(19) United States
(12) Patent Application Publication
(10) Pub. No.: US 2002/0010644 A1
(43) Pub. Date: Jan. 24, 2002

(54) B2B e-commerce system for plant construction implemented on web server and method thereof

(76) Inventor: Sang-Hun Han, Suwon (KR)

Correspondence Address: JACOBSON, PRICE, HOLMAN & STERN, PROFESSIONAL LIMITED LIABILITY COMPANY, 400 SEVENTH STREET, N.W., WASHINGTON, DC, 20004, US

(21) Appl. No.: 09/871,817

(22) Filed: Jun. 4, 2001

(30) Foreign Application Priority Data
Jul. 19, 2000 (KR) 10-2000-41460

(51) Int. Cl. G06F 17/60

(52) U.S. Cl. 705/26; 705/28

(57) ABSTRACT

Disclosed is a to a B2B e-commerce system for plant construction which is implemented on a web server accessed by a client computer of a material vendor that supplies plant materials, a client computer of a client that carries out a plant construction project, and a client computer of an affiliated company.

### BACKGROUND OF THE INVENTION

1. Field of the Invention

The present invention relates to a business-to-business (B2B) electronic commerce (e-commerce) system for plant construction, and more particularly to a B2B e-commerce system for plant construction which is implemented on a web server accessed by a client computer of a material vendor that supplies plant materials and a client computer of a client that carries out a plant construction project.

2. Description of the Related Art

Generally, an e-market place means a virtual place where commercial transactions between vendors and consumers are carried out, and various actions related thereto are performed. The B2B e-commerce system according to the present invention presents a kind of e-market place for the B2B commerce performed based on the Internet, and especially presents an e-market place model suitable for the plant construction.

The plant market currently has the market scale of three hundred trillion Won (Korean currency) per year throughout the world. However, up to the present, any generalized purchasing service provider is absent, and any proper connection ring between clients and vendors is absent due to the insufficient experts or information per region. Especially, the actual participation results of domestic companies with respect to domestic projects having the scale of fifty trillion Won are extremely sluggish, and this is because overseas business networks are insufficient and there exist great difficulty in performing individual publicity activities. Meanwhile, as the digital economy grows rapidly and the demand for prompt response becomes greater in the B2B commerce, the necessity of real-time information exchange and cost reduction is rapidly increasing. The applicant has reached the present invention after groping for a new business model that can satisfy the above-described necessity by properly utilizing the purchasing experts and overseas business networks that the applicant possesses and relationship with affiliated companies and overseas clients, based on the overseas project performing experience accumulated for a long time.

### SUMMARY OF THE INVENTION

Therefore, an object of the invention is to solve the problems involved in the related art, and to provide a B2B e-commerce system which can reduce the cost and project performing period, and provide an effective project processing order for each project or client with the security maintained by providing an optimum e-market place in performing plant projects having much off-line process.

In accordance with the present invention, this object is accomplished by providing a B2B commerce system for plant construction that is implemented on a web server accessed by a client computer of a material vendor and a client computer of a client carrying out a plant construction project, the system comprising:

a material database for storing material items required for the plant construction by specified categories along with material vendor information;

a certification database for storing certification information including identifiers (IDs) and passwords by material vendors and project teams of a client;

a project database for storing a project name of the client, materials required for the project, and material vendor information finally selected for the materials;

a project registration section for registering the project by repeating the steps of storing the project teams of the client in the certification database after giving the certification information including the IDs and passwords to the project teams, presenting the materials required for the project to the certified project teams of the client by the specified categories, and adding the items selected by the project teams of the client to the project database;

an estimate requesting section for presenting the materials registered in the project registration section with the material vendor information by searching the material database, and forwarding an estimate request with respect to at least one material vendor selected by the project team of the client;

an estimate processing section for uploading an estimate from the material vendor, and presenting the estimate so that the certified project team of the client can download the estimate;

a purchase order processing section for presenting a purchase order uploaded by the certified project team of the client that has downloaded the estimate so that the material vendor can download the purchase order; and

a vendor print processing section for presenting a vendor print uploaded by the material vendor that has downloaded the purchase order so that the certified project team of the client can download the vendor print, and processing approval or return of the vendor print.

According to the present invention, the project database further includes information on the material vendor to which the client has sent the estimate request, information on the material vendor which has sent the estimate to the client, and information on the material vendor to which the client has sent the purchase order for each project, wherein the estimate requesting section, estimate processing section and purchase order processing section additionally update corresponding fields in the project database.

Preferably, the B2B commerce system for plant construction according to the present invention further comprises a progress information processing section for presenting a progress report uploaded by the material vendor that has received the purchase order so that the certified project team of the client can download the progress report.

In another aspect of the present invention, there is provided a system for a material vendor that visits a server of a B2B commerce system, comprising:

a material database for storing material items required for the plant construction by specified categories along with material vendor information;

a certification database for storing certification information including identifiers (IDs) and passwords by material vendors and project teams of a client;

an affiliated company database for storing affiliated company information including information on cost calculation items for calculating a cost for each service of a plurality of affiliated companies;

a project database for storing a project name of the client, materials required for the project, and material vendor information finally selected for the materials;

an estimate request processing section for receiving an estimate request from the client;

an estimate processing section for uploading an estimate;

a purchase order processing section for receiving a purchase order from the client; and

a vendor print processing section for uploading a vendor print;

wherein the estimate processing section includes:

an affiliated company estimate request processing section for receiving cost-related items from the affiliated company database for estimate-requested materials which constitute the project extracted from the estimate request, and uploading a file including detailed estimate request information so that the affiliated company can download the file; and

a service cost outputting section for receiving and outputting an amount of cost estimated by the affiliated company for each related service.

In still another aspect of the present invention, there is provided a B2B commerce method for plant construction that is implemented on a web server accessed by a client computer of a material vendor and a client computer of a client carrying out a plant construction project, the method comprising:

a project registration step of registering the project by repeating the steps of storing project teams of the client in a certification database after giving certification information including IDs and passwords to the project teams, presenting materials required for the project to the certified project teams of the client by specified categories, and adding items selected by the project teams of the client to a project database;

an estimate requesting step of presenting the materials registered at the project registration step with material vendor information by searching a material database that stores material items required for the plant construction by specified categories and the material vendor information, and forwarding an estimate request with respect to at least one material vendor selected by the project team of the client;

an estimate processing step of uploading an estimate from the material vendor, and presenting the estimate so that the certified project team of the client can download the estimate;

a purchase order processing step of presenting a purchase order uploaded by the certified project team of the client that has downloaded the estimate so that the material vendor can download the purchase order; and

a vendor print processing step that includes a step of presenting a vendor print uploaded by the material vendor that has downloaded the purchase order so that the certified project team of the client can download the vendor print, and a step of processing approval or return of the vendor print.

Preferably, the B2B commerce method for plant construction according to the present invention further comprises a progress information processing step of presenting a progress report uploaded by the material vendor or an affiliated expediting and inspection company that has received the purchase order so that the certified project team of the client can download the progress report.

### BRIEF DESCRIPTION OF THE DRAWINGS

The above objects, and other features and advantages of the present invention will become more apparent after a reading of the following detailed description when taken in conjunction with the drawings, in which:

FIG. 1 is a flowchart illustrating a general working process of the plant project according to a preferred embodiment of the present invention;

FIG. 2 is a view illustrating a displayed picture of an inquired general information after registration of a client is completed;

FIG. 3 is a view illustrating an example of a main displayed picture for project registration;

FIG. 4 is a view illustrating an example of a displayed picture for recommendation and selection of a material vendor;

FIG. 5 is a view illustrating an example of a displayed picture for selection of a candidate that will send an estimate request by recommendation of a material vendor;

FIG. 6 is a view illustrating an example of a displayed picture for processing sending of an estimate request;

FIG. 7 is a view illustrating an example of a displayed picture for processing an estimate after an estimate request is received;

FIG. 8 is a view illustrating an example of a displayed picture for the material vendor's requesting of an estimate of the FIH cost to an affiliated company and downloading of the estimate;

FIG. 9 is a view illustrating an example of a displayed picture for uploading a purchase order for project materials;

FIG. 10 is a view illustrating an example of a displayed picture for the client's uploading of a purchase order by selecting a material vendor with respect to one material; and

FIG. 11 is a view illustrating the construction of a program module of a web server implementing the B2B commerce system for plant construction according to a preferred embodiment of the present invention.

### DETAILED DESCRIPTION OF THE PREFERRED EMBODIMENTS

Hereinafter, a B2B commerce system and method according to the present invention will be described with respect to preferred embodiments illustrated in the annexed drawings.

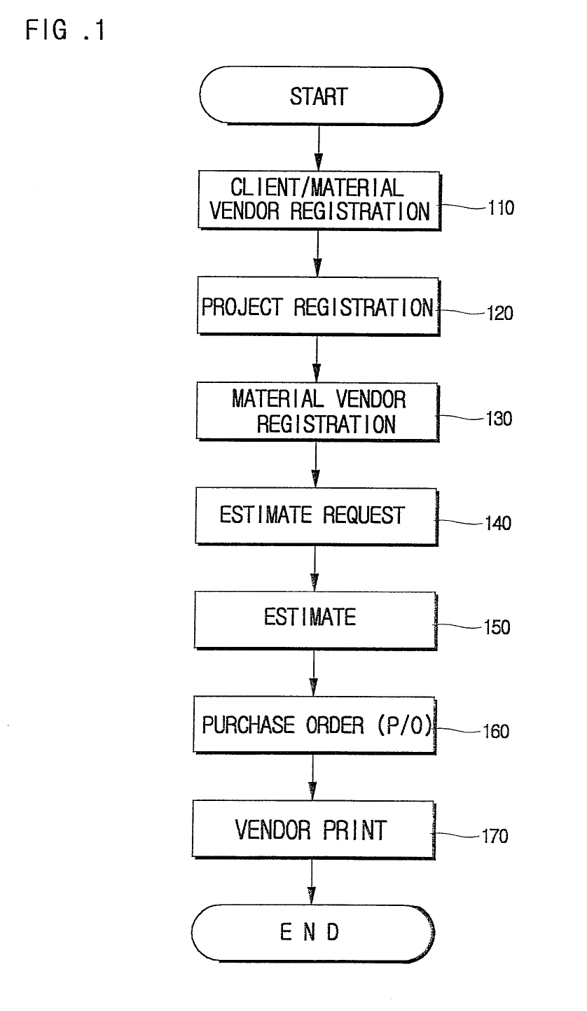

FIG. 1 is a flowchart illustrating a general working process of the plant project according to a preferred embodiment of the present invention.

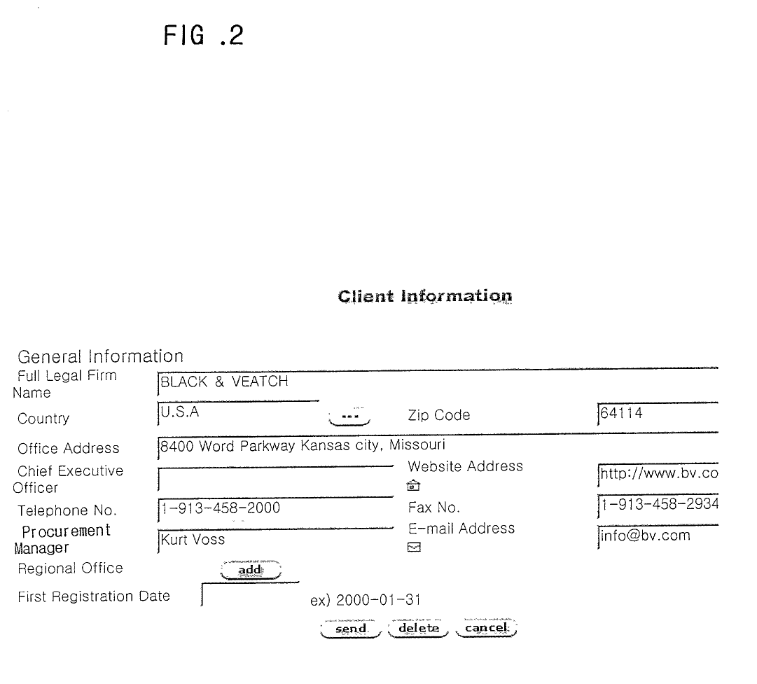

Referring to FIG. 1, the step 110 is a registration step of a client that carries out a plant construction project with respective material vendors. This registration is performed by writing a registration request on a web site, and it may include a contract procedure performed by adding a general contract basis. FIG. 2 is a view illustrating a displayed picture for an inquired general information after the client registration is completed. The client information is used as an important information when the material vendor prepares the estimate, and if the material vendor performs a log-in as a member in relation to the commerce, it is preferable that much more detailed information including various kinds of data whereby the credit rating of the client can be known is provided. The registration of the material vendor is much more complicated. The most important information on the material vendor is the materials provided by the material vendor. Accordingly, in addition to the general information similar to that shown in FIG. 2, the supply materials are classified by specified categories, for example, in case of a chemistry-related plant, into groups of mechanism, electricity, instruments, piping, etc., and then each classified group is further classified into detailed items to facilitate the search or input operations.

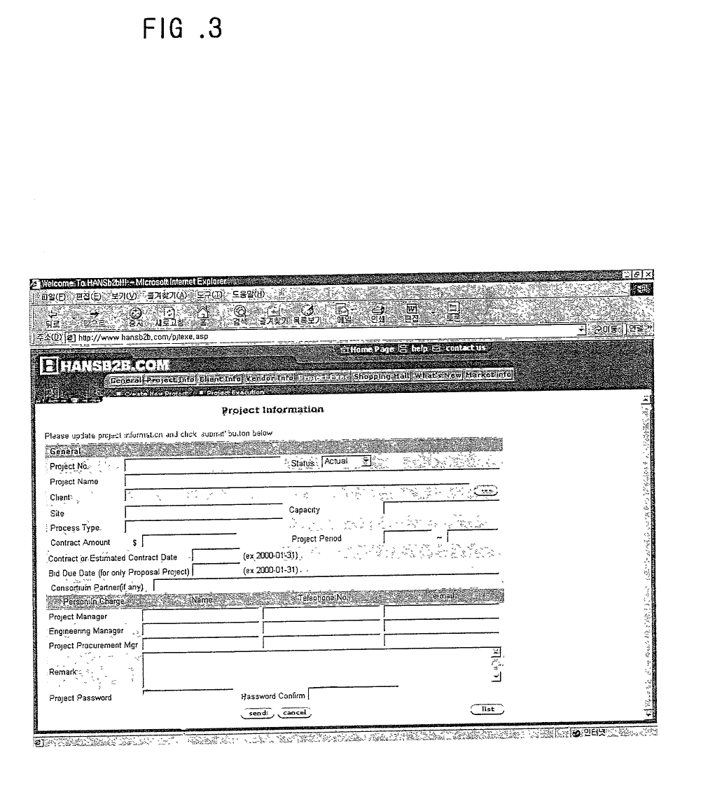

The step 120 is a project registration step. This step is performed by the project team of the client that carries out the plant construction project. FIG. 3 is a view illustrating an example of the main displayed picture for the project registration. In proceeding with the project, it is preferable to limit the information for each client to ensure fairness in bidding and so on, and further, it is preferable to limit the information for each project team even in the same client. In the embodiment of the present invention, the certification database gives IDs and passwords for each client, material vendor, and project team of the client as well, and in case of the log-in by the user, the user is discriminated by the ID and password, and thus limited not to access detailed commerce information of another user. This rule is applied to the affiliated companies in the same manner. Accordingly, an important role of the step 120 is to give the IDs and passwords to the project teams and to register the general information as shown in the lowest portion of FIG. 3.

Another important role of the step 120 is to input materials required for the plant project without omission. Though the whole design drawing is necessary to a provider in charge of the final construction, the specifications of a large number of materials constitute the main contents of the project in the actual plant construction. Accordingly, in the embodiment of the present invention, the project registration is performed by repeating input of the materials required for the project by the above-described specified categories.

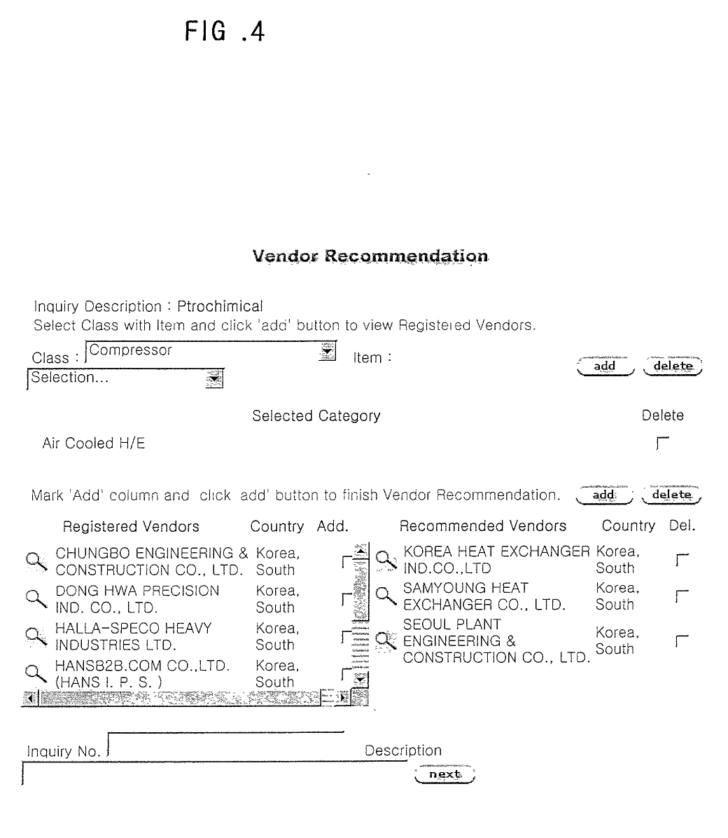

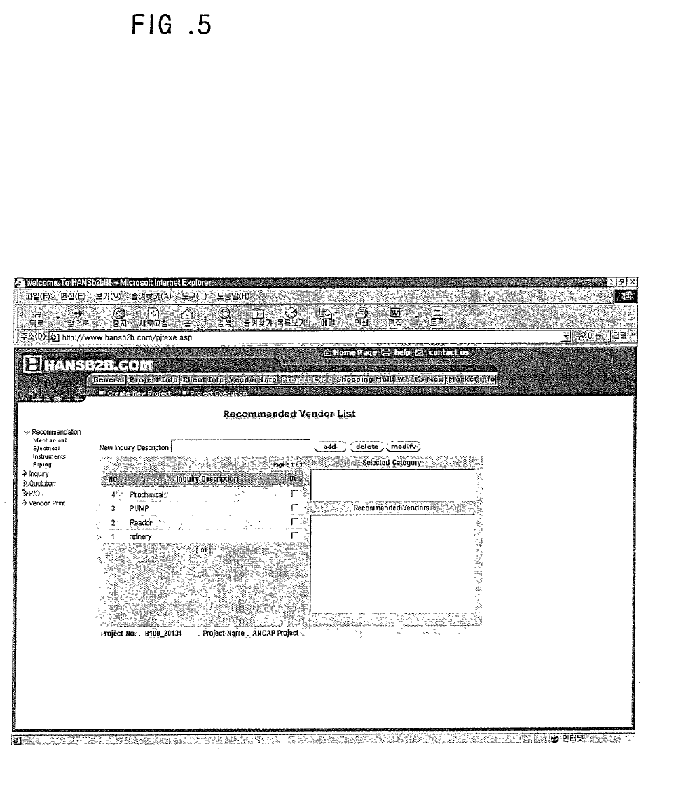

After completion of the project registration, at least one possible and proper material vendor by registered items is presented by the B2B commerce system according to the present invention, and the estimate request is sent to the material vendor selected by the project team of the client. The step 130 is a material vendor recommendation step. This material vendor recommendation step may be performed through a separate menu, but it may be more natural for business flow to include this step in the step of forwarding the estimate request. With respect to the items inputted at the project registration step 120, all the registered material vendors are listed by accessing the information on the material vendors registered at the step 110, and several companies among them are selected. FIG. 4 is a view illustrating an example of a displayed picture for such recommendation and selection of the material vendors. FIG. 5 is a view illustrating an example of a displayed picture for selection of a candidate that will send the estimate request by selecting a proper material vendor among all the registered material vendors which supply the corresponding material through the repetition of the above-described process with respect to all the items registered for the project.

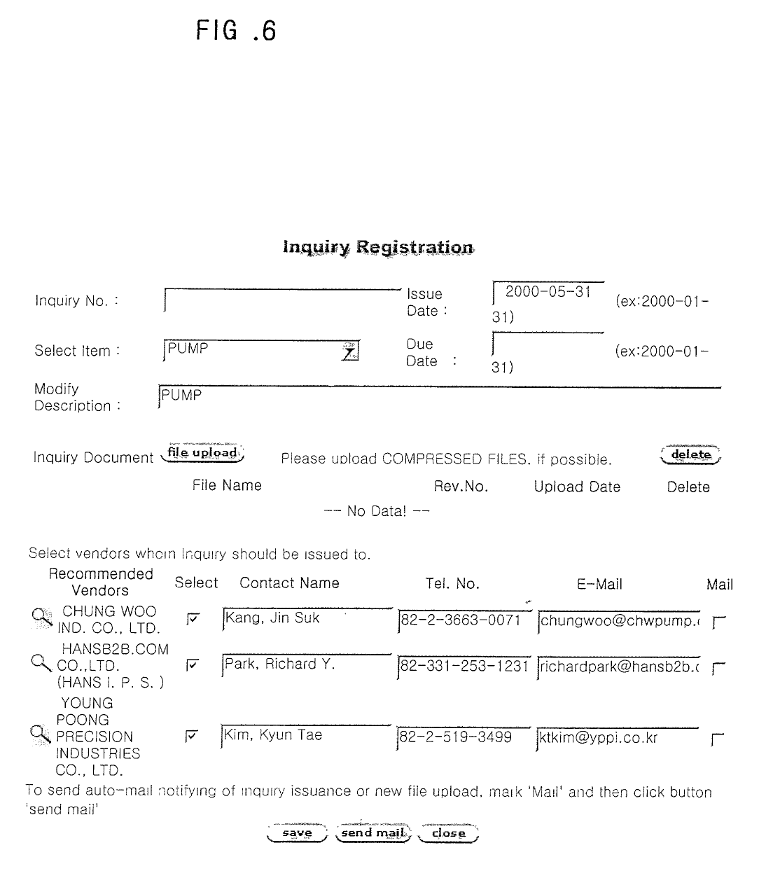

The step 140 is an estimate request forwarding step. FIG. 6 is a view illustrating an example of a displayed picture for processing sending of the estimate request. The estimate request in the form of an uploaded file is sent to a material vendor selected through a selection window among the material vendors selected at the step 130. This process is repeated for all the material items constituting the project. The estimate request mail is automatically sent to the material vendor that is a member, and by the log-in to the B2B commerce system site according to the present invention, the corresponding material vendor can download the estimate request uploaded by the client as shown in FIG. 6 with respect to only the material items for which the estimate is requested. It is not compulsory that this estimate request is uploaded or downloaded, but it may be sent, being annexed in an e-mail. However, it is preferable for the whole project management to use uploading and downloading of the estimate request rather than sending the e-mail since the estimate request includes a large-capacity file of diverse formats.

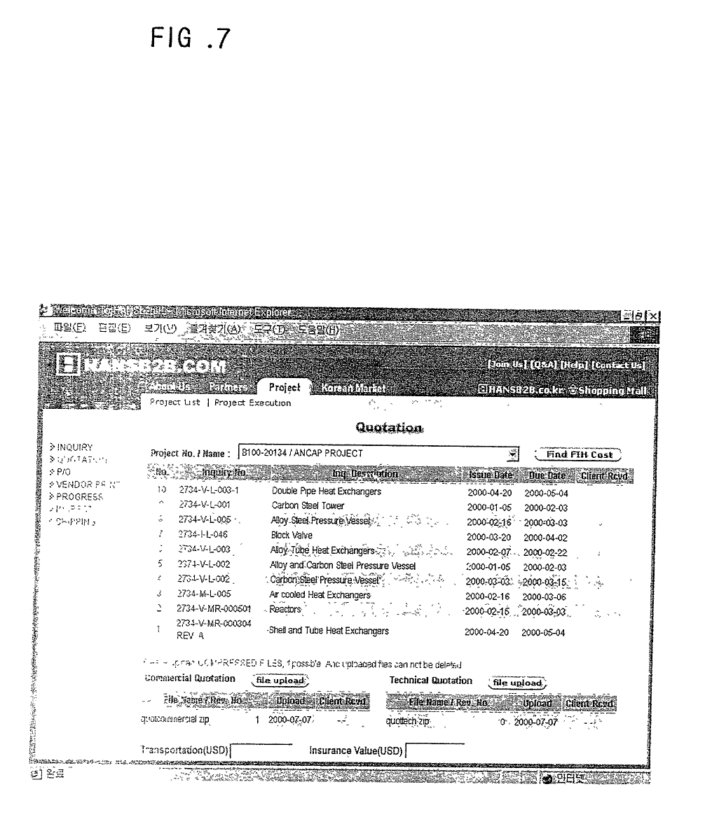

The step 150 is an estimate processing step. FIG. 7 is a view illustrating an example of a displayed picture for uploading the estimate after checking the received estimate request through the material vendor's search by categories. The client can confirm and download the estimate through the similar search by categories.

The material vendor can calculate costs of carriage, insurance, and package using a ‘find FIH cost’ function related to the affiliated company according to the present invention. At this time, the package cost that is not included in the estimate amount is not displayed on a screen, and the costs of carriage and insurance may or may not be included according to the estimate request terms. However, the material vendor can calculate an FIH cost, and this may be the ground for calculation of the total procurement cost.

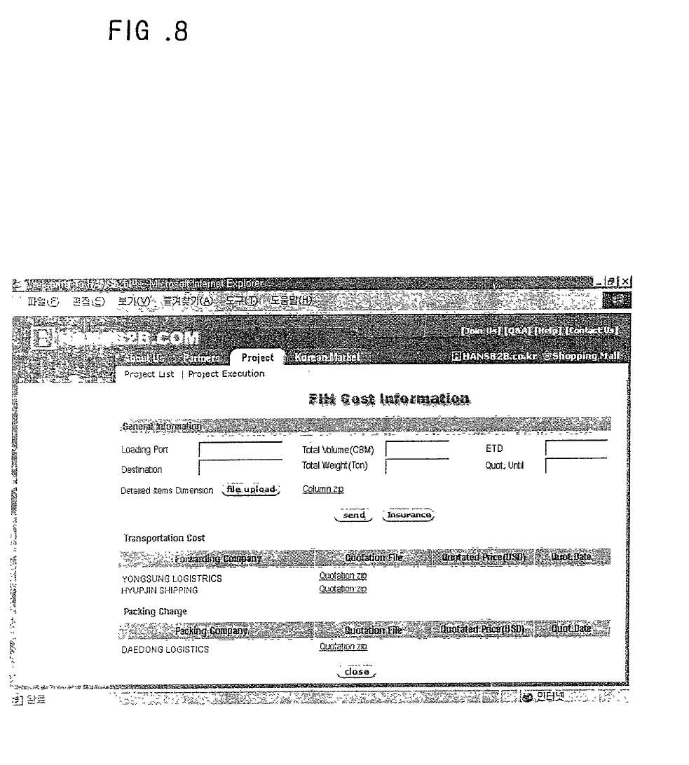

FIG. 8 is a view illustrating an example of a displayed picture for the material vendor's requesting of an estimate of the FIH cost to the affiliated company and downloading of the estimate. When submitting the estimate, the material vendor provides the general information to the affiliated transportation, packing, and insurance companies, and the affiliated companies submits the corresponding estimate, so that the FIH cost can be calculated. The FIH cost as calculated above is provided to the client, and is used as an important ground for selecting the vendor.

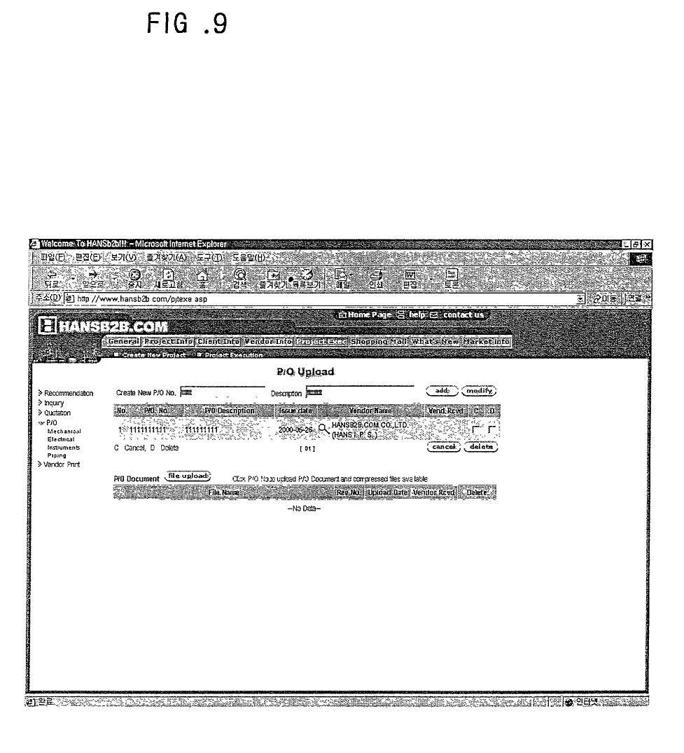

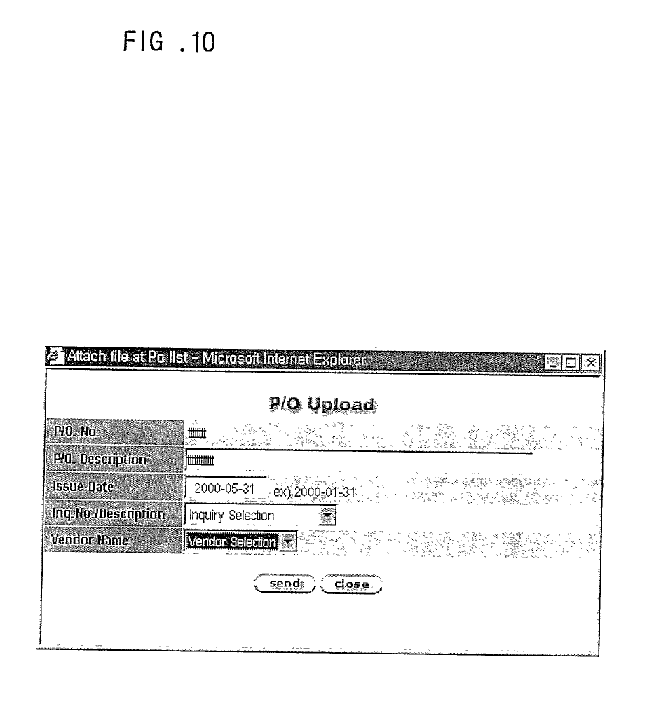

The step 160 is a step whereby the client checks the received estimate, selects a proper company among the companies which have sent the estimate, and forwarding the purchase order (P/O) to the selected company. FIG. 9 is a view illustrating an example of a displayed picture for uploading the purchase order for the project material, and FIG. 10 is a view illustrating an example of a displayed picture for the client's uploading of the purchase order by selecting a material vendor with respect to one project material. The displayed picture for uploading all documents has a menu similar to that of the displayed picture for uploading the purchase order. The step 170 is a step of sending the vendor print that is sent if the final specification is decided with respect to the respective material by the material vendor. The vendor print sent to the client may be approved or returned.

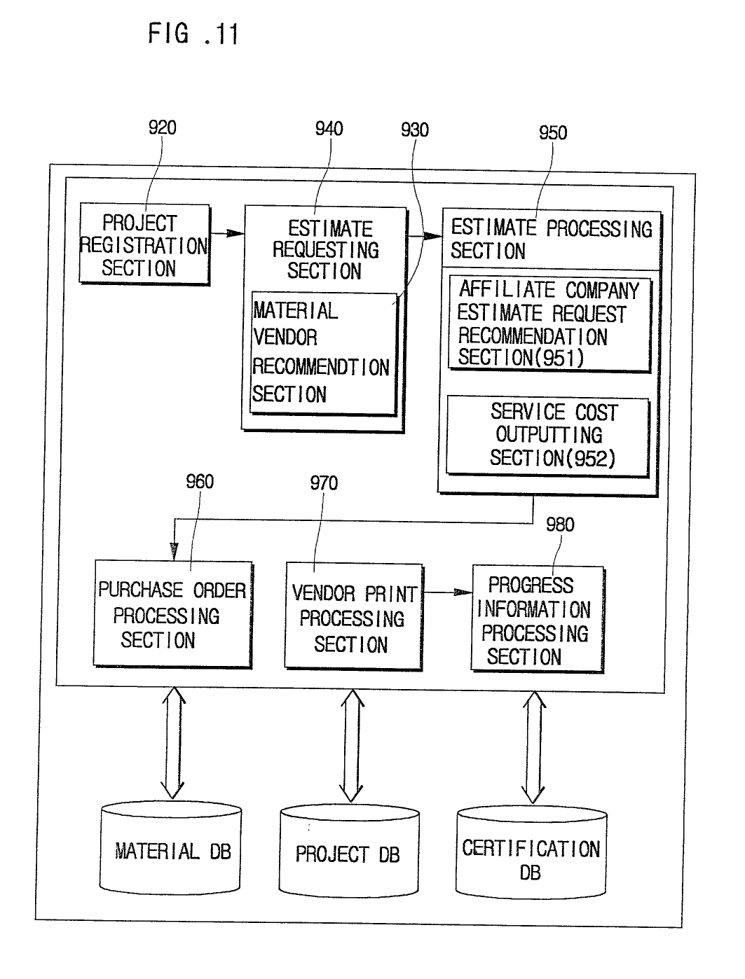

FIG. 11 is a view illustrating the construction of a program module of a web server implementing the B2B commerce system for plant construction according to the preferred embodiment of the present invention.

The web server includes a material database 911 for storing material items required for the plant construction by specified categories along with material vendor information, a certification database 912 for storing certification information including IDs and passwords for each material vendor and project team of the client, an affiliated company database for storing affiliated company information (i.e., information on insurance, transportation, and packing companies) related to the project proceeding except for the material vendor and the client, and a project database 913 for storing the project name of the client, materials required for the project, and the material vendor information finally selected by the materials. The material items may be classified into multi-stage layer structure, for example, 3-stage layer structure.

A project registration section 920 registers the project by repeating the steps of storing the project teams of the client in the certification database after giving the certification information including the IDs and passwords to the project teams, presenting the materials required for the project to the certified project teams of the client by the specified categories, and adding the items selected by the project teams of the client to the project database.

An estimate requesting section 940 presents the materials registered in the project registration section with the material vendor information by searching the material database, and forwards the estimate request to at least one material vendor selected by the project team of the client through a selection process for limiting candidates to which the estimate is requested.

The estimate requesting section 940 includes a material vendor recommendation section 930, and presents the materials registered in the project registration section by categories along with the material vendor information by searching the material database. Preferably, the estimate requesting section includes the selection process for limiting the candidates to which the estimate is requested.

However, the estimate requesting section 940 may be implemented by a module separated from the material vendor recommendation section 930.

The estimate request may be sent through uploading or downloading of the estimate request.

An estimate processing section 950 receives the estimate uploaded from the corresponding material vendor, and presents the estimate to the certified project team of the client to download the estimate to the certified project team. A FIH cost processing section 950-1 is a part of the estimate processing section. The estimate processing section sends the estimate in a manner that the material vendor inputs the general information for the FIH cost estimate to the affiliated company, and requests the estimate from the affiliated company. Then, the inquired affiliated company uploads the estimate, and then the material vendor downloads it. Also, the material vendor may include the FIH cost in the estimate in connection with the cost of the materials, or directly input the FIH cost to the cost sections of transportation and insurance.

The purchase order processing section 960 certifies the logged-in project team of the client, and sends the purchase order by receiving the purchase order uploaded by categories with respect to the received materials, and presenting the purchase order to the material vendor through the download process.

The vendor print processing section 970 processes the contract for settlement of the FIH cost between the material vendor and the affiliated company. Specifically, the vendor print processing section 970 receives the vendor print uploaded from the material vendor, and downloads the vendor printer to the logged-in project team of the client by presenting to the project team the corresponding vendor print by categories with respect to the uploaded material. In addition, the vendor print processing section approves or returns the vendor print, and reports the result to the material vendor.

According to the present invention, the project database 913 further includes information on the material vendor to which the client has sent the estimate request, information on the material vendor which has sent the estimate to the client, and information on the material vendor to which the client has sent the purchase order for each project. The estimate requesting section 940, estimate processing section 950 and purchase order processing section 960 additionally update corresponding fields in the project database. Accordingly, the history management for each material vendor, client, and affiliated company becomes possible, resulting in that it is used as basic data for estimating the credit ratings, and enables the project valuation after the project terminates.

A progress information processing section 980 presents a progress report uploaded by the material vendor or an affiliated expediting and inspection company that has received the purchase order so that the certified project team of the client can download the progress report by the specified categories. Thus, the progress management of the whole project becomes possible by on-line.

As described above, the present invention has the advantages in that it enables an effective project management by managing certification information of the subdivided project teams and presenting different commerce information for each proceeding stage of the commerce. Also, according to the present invention, the post valuation of the client, material vendor, affiliated company, and further the project itself becomes possible by managing the history at each progress step, and the cost and time are greatly reduced in the B2B commerce by presenting an optimum model of the e-market place for the plant project by on-line.

Also, the present invention contributes to the activation of the e-market place and constructs a steady plant community by exchanging information with the affiliated companies having a definite business relationship in performing the project, and thus provides so-called a win-win system that seeks profits of all the parties concerned.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A business-to-business (B2B) commerce system for plant construction that is implemented on a web server accessed by a client computer of a material vendor and a client computer of a client carrying out a plant construction project, the system comprising:
a material database for storing material items required for the plant construction by specified categories along with material vendor information;
a certification database for storing certification information including identifiers (IDs) and passwords by material vendors and project teams of a client;
a project database for storing a project name of the client, materials required for the project, and material vendor information finally selected for the materials;
a project registration section for registering the project by repeating the steps of storing the project teams of the client in the certification database after giving the certification information including the IDs and passwords to the project teams, presenting the materials required for the project to the certified project teams of the client by the specified categories, and adding the items selected by the project teams of the client to the project database;
an estimate requesting section for presenting the materials registered in the project registration section with the material vendor information by searching the material database, and forwarding an estimate request with respect to at least one material vendor selected by the project team of the client;
an estimate processing section for uploading an estimate from the material vendor, and presenting the estimate so that the certified project team of the client can download the estimate;
a purchase order processing section for presenting a purchase order uploaded by the certified project team of the client that has downloaded the estimate so that the material vendor can download the purchase order; and
a vendor print processing section for presenting a vendor print uploaded by the material vendor that has downloaded the purchase order so that the certified project team of the client can download the vendor print, and processing approval or return of the vendor print.

2. The B2B commerce system as claimed in claim 1, wherein the project database further includes information on the material vendor to which the client has sent the estimate request, information on the material vendor which has sent the estimate to the client, and information on the material vendor to which the client has sent the purchase order for each project;
wherein the estimate requesting section, estimate processing section and purchase order processing section additionally update corresponding fields in the project database.

3. The B2B commerce system as claimed in claim 1 or 2, further comprising a progress information processing section for presenting a progress report uploaded by the material vendor that has received the purchase order so that the certified project team of the client can download the progress report.

4. A business-to-business (B2B) commerce system for plant construction that is implemented on a web server accessed by client computers of a plurality of material vendors, a client computer of a client carrying out a plant construction project, and a plurality of affiliated company computers related to commerce between the respective material vendors and the client, the system comprising:
a material database for storing material items required for the plant construction by specified categories along with material vendor information;
a certification database for storing certification information including identifiers (IDs) and passwords by material vendors and project teams of a client;
an affiliated company database for storing affiliated company information including information on cost calculation items for calculating a cost for each service of a plurality of affiliated companies;
a project database for storing a project name of the client, materials required for the project, and material vendor information finally selected for the materials;
an estimate request processing section for receiving an estimate request from the client;
an estimate processing section for uploading an estimate;
a purchase order processing section for receiving a purchase order from the client; and
a vendor print processing section for uploading a vendor print;
wherein the estimate processing section includes:
an affiliated company estimate request processing section for receiving cost-related items from the affiliated company database for estimate-requested materials which constitute the project extracted from the estimate request, and uploading a file including detailed estimate request information so that the affiliated company can download the file; and
a service cost outputting section for receiving and outputting an amount of cost estimated by the affiliated company for each related service.

5. A business-to-business (B2B) commerce method for plant construction that is implemented on a web server accessed by a client computer of a material vendor and a client computer of a client carrying out a plant construction project, the method comprising:
a project registration step of registering the project by repeating the steps of storing project teams of the client in a certification database after giving certification information including IDs and passwords to the project teams, presenting materials required for the project to the certified project teams of the client by specified categories, and adding items selected by the project teams of the client to a project database;
an estimate requesting step of presenting the materials registered at the project registration step with material vendor information by searching a material database that stores material items required for the plant construction by specified categories and the material vendor information, and forwarding an estimate request with respect to at least one material vendor selected by the project team of the client;
an estimate processing step of uploading an estimate from the material vendor, and presenting the estimate so that the certified project team of the client can download the estimate;
a purchase order processing step of presenting a purchase order uploaded by the certified project team of the client that has downloaded the estimate so that the material vendor can download the purchase order; and
a vendor print processing step that includes a step of presenting a vendor print uploaded by the material vendor that has downloaded the purchase order so that the certified project team of the client can download the vendor print, and a step of processing approval or return of the vendor print.

6. The B2B commerce method as claimed in claim 5, further comprising a progress information processing step of presenting a progress report uploaded by the material vendor that has received the purchase order so that the certified project team of the client can download the progress report.

7. A business-to-business (B2B) commerce method for plant construction that is implemented on a web server accessed by a client computer of a material vendor, a client computer of a client carrying out a plant construction project, and a client computer of an affiliated company, the method comprising:
a step of receiving an estimate request from the client;
an estimate processing step of uploading an estimate;
a purchase order processing step of receiving a purchase order from the client; and
a vendor print processing step of uploading a vendor print;
wherein the estimate processing step includes:
an affiliated company estimate request processing step of receiving cost-related items from the affiliated company database for estimate-requested materials which constitute the project extracted from the estimate request, and uploading a file including detailed estimate request information so that the affiliated company can download the file; and
a service cost outputting step of receiving and outputting an amount of cost estimated by the affiliated company for each related service.
